(19) United States
(12) Patent Application Publication
(10) Pub. No.: US 2021/0018715 A1
(43) Pub. Date: Jan. 21, 2021

(54) IMAGE LENS UNIT AND ELECTRONIC DEVICE

(71) Applicant: KYOCERA CORPORATION, Kyoto-shi, Kyoto (JP)

(72) Inventors: Takaharu FUJII, Tokorozawa-shi, Saitama (JP); Satoru KIHARA, Akishima-shi, Tokyo (JP); Takashi SAOTOME, Ome-shi, Tokyo (JP); Daisuke KANAI, Ome-shi, Tokyo (JP); Kousuke SUGIKI, Akishima-shi, Tokyo (JP)

(21) Appl. No.: 17/043,664

(22) PCT Filed: Dec. 28, 2018
(86) PCT No.: PCT/JP2018/048563

§ 371 Date: Sep. 30, 2020

(30) Foreign Application Priority Data
Mar. 30, 2018 (JP) 2018-069206
Mar. 30, 2018 (JP) 2018-069207

(51) Int. Cl. G02B 7/02; G02B 9/10; G02B 5/00; G02B 13/18

(52) U.S. Cl. CPC G02B 7/021; G02B 13/18; G02B 5/005; G02B 9/10

(57) ABSTRACT

An imaging lens unit with a plurality of lenses may be incorporated in a lens barrel of resin, the lenses may include, in order from the object side, a first lens group, an aperture, and a second lens group. The first lens group may include, from the object side, a meniscus lens as a first lens with a convex surface on the object side, and a meniscus lens as a second lens with a convex surface on the object side. The second lens group may include, from the object side, a convex lens as a third lens, a biconvex lens as a fourth lens, a biconvex lens as a fifth lens, and a concave lens as a sixth lens. The first lens to the sixth lens may be incorporated in the lens barrel with a reference position between the third lens and the fourth lens.

### CROSS-REFERENCE TO RELATED APPLICATIONS

This application is a national stage entry according to 35 U.S.C. 371 of PCT Application No. PCT/JP2018/048563 filed on Dec. 28, 2018, which claims priority to Japanese Application No. 2018-069206 filed on Mar. 30, 2018, and Japanese Application No. 2018-069207 filed on Mar. 30, 2018, which are entirely incorporated herein by reference.

### TECHNICAL FIELD

The present disclosure relates to an imaging lens unit and an electronic device.

### BACKGROUND

In recent years, surveillance cameras and vehicle cameras have become widespread. As an imaging lens unit installed in surveillance cameras and vehicle cameras (hereinafter “vehicle cameras”) may be used in a wide variety of environments. The use of these products in cold districts to tropical districts may be taken into consideration. Therefore, stable performance over the temperature range from low to high in the use environment may be desired for the vehicle cameras.

As a method of storing a lens in a lens barrel, the outer diameter of the lens may be made smaller than the inner diameter of the lens barrel, and the lens is sandwiched using a presser ring (a retainer) that is fixed with a screw from an opening of the lens barrel. For example, it is discussed that a plurality of lenses may be inserted into the lens barrel, secured with an adhesive, and finally tightened to the presser ring (Patent Document 1).

Another method of storing the lens in the lens barrel may be to make the outer diameter of the lens larger than the inner diameter of the lens barrel and incorporate it by applying pressure. For example, it is discussed to provide a buffer portion between the lens and the lens barrel to press-fit the lens (Patent Document 2).

Patent Document 3 discusses an imaging optical system which may be constituted of 5 elements and 5 groups for maintaining high resolution in a wide temperature range from low to high temperatures.

Patent Document 4 discusses an optical system that may have 6 elements and 5 groups which may be configured by a front lens group of 3 elements and 3 groups and a rear lens group of 3 elements and 2 groups.

Patent Document 1: Japanese Unexamined Patent Publication No. 2009-244939

Patent Document 2: Japanese Patent Publication No. 6182380

Patent Document 3: Japanese Unexamined Patent Publication No. 2016-114648

Patent Document 2: Japanese Patent Publication No. 5042767

### SUMMARY

The imaging lens unit of the present disclosure may have a plurality of lenses incorporated in the lens barrel made of resin. The plurality of lenses may be composed, in order from an object side, of a first lens group having a negative refractive power and a second lens group having a positive refractive power, sandwiching an aperture. The first lens group may include, from the object side, a meniscus lens (a first lens) having a negative refractive power in which a convex surface is formed on the object side, and a meniscus lens (a second lens) having a negative refractive power in which a convex surface may be formed on the object side. The second lens group may include, from the object side, a convex lens (a third lens) having a positive refractive power, a biconvex lens (a fourth lens) having a positive refractive power, a biconvex lens (a fifth lens) having a positive refractive power, and a concave lens (a sixth lens) having a negative refractive power. The first lens to the sixth lens may be incorporated in the lens barrel with a reference position between the third lens and the fourth lens of the second lens group, wherein the first lens to the third lens may be incorporated from the object side of the lens barrel, and the fourth lens to the sixth lens may be incorporated from an image surface side.

The imaging lens unit of the present disclosure may have a plurality of lenses incorporated in the lens barrel made of resin. The plurality of lenses may include an intermediate lens group which may be press-fitted into the lens barrel and both end lens groups disposed on both sides of the intermediate lens group in the optical axis direction and fastened in the lens barrel by the retainer.

The electronic device of the present disclosure may be provided with the imaging lens unit.

### BRIEF DESCRIPTION OF THE DRAWINGS

FIG. 1 is a perspective view showing a camera having a lens unit according to a non-limiting embodiment of the present disclosure.

FIG. 2 is a sectional view of the lens unit shown in FIG. 1.

FIG. 3 is a broken perspective view of the lens unit shown in FIG. 1.

FIG. 4 is a perspective sectional view of a lens barrel of the lens unit shown in FIG. 1.

FIG. 5 is a schematic diagram showing lens placement in numerical examples.

FIG. 6 is a lens aberration diagram of numerical example 1.

FIG. 7 is an MTF (Modulation Transfer Function) characteristic diagram of numerical example 1.

FIG. 8 is a lens aberration diagram of numerical example 2.

FIG. 9 is an MTF characteristic diagram of numerical example 2.

FIG. 10 is a lens aberration diagram of numerical example 3.

FIG. 11 is an MTF characteristic diagram of numerical example 3.

FIG. 12 is a lens aberration diagram of numerical example 4.

FIG. 13 is an MTF characteristic diagram of numerical example 4.

FIG. 14 is a lens aberration diagram of numerical example 5.

FIG. 15 is an MTF characteristic diagram of numerical example 5.

FIG. 16 is a sectional view showing the lens unit according to another non-limiting embodiment of the present disclosure.

FIG. 17 is a perspective view of the lens unit shown in FIG. 16.

### DETAILED DESCRIPTION

Hereinafter, a non-limiting embodiment of the present disclosure will be described in detail with reference to the drawings.

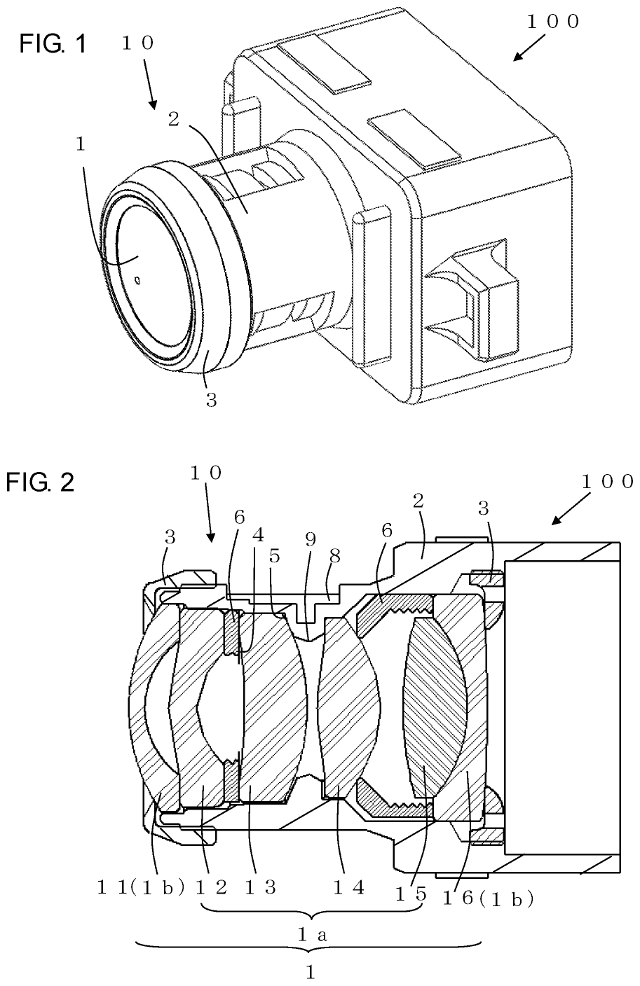

FIG. 1 shows a camera 100 including the imaging lens unit (hereinafter “lens unit”) 10 according to a non-limiting embodiment of the present disclosure. The lens unit 10 is constituted with a lens barrel 2 and a lens group 1 having a plurality of lenses which is incorporated in the lens barrel 2. The lens group 1 includes a first lens 11 to a sixth lens 16.

The lens group 1 is composed, in order from the object side, of a front group having a negative refractive power (hereinafter “the first lens group”) and a rear group having a positive refractive power (hereinafter “the second lens group), sandwiching the aperture. The first lens group includes, from the object side, the meniscus lens (the first lens) having a negative refractive power in which the convex surface is formed on the object side and the meniscus lens (the second lens) having a negative refractive power in which the convex surface is formed on the object side. The second lens group includes, from the object side, the convex lens (the third lens) having a positive refractive power, the biconvex lens (the fourth lens) having a positive refractive power, the biconvex lens (the fifth lens) having a positive refractive power, and the concave lens (the sixth lens) having a negative refractive power.

As shown in FIG. 2, the lens group 1 includes an intermediate lens group 1a and both end lens groups 1b. The intermediate lens group 1a includes a second lens 12 to a fifth lens 15. Each of the intermediate lens group 1a is press-fitted and incorporated into the lens barrel 2.

The both end lens groups 1b are disposed on both sides of the intermediate lens group 1a in the optical axis direction. The both end lens groups 1b include a first lens 11 on the most subject (object) side and a sixth lens 16 on the most image surface (sensor) side. The both end lens groups 1b are fastened in the lens barrel 2 by a retainer 3.

The material of the lens contained in the lens group 1 is not particularly limited. For instance, glass lenses, thin glass lenses, resin lenses, and the like are used. The lenses may be used in appropriate combinations according to the application. The number, diameter, thickness, and the like of lenses included in the lens group 1 may also be different as long as they can be incorporated into the lens barrel 2.

The lens barrel 2 is a cylindrical member made of resin that accommodates the lens group 1 inside. The lens barrel 2 has openings at both ends of the object side and the image surface side.

The lens barrel 2 may be designed by simulating the minimum necessary press-in pressure (pressure generated on the lens in the direction perpendicular to the optical axis) capable of holding the lenses in the lens barrel within the operating environment temperature range. The press-in pressure is 20 MPa to 70 MPa. It may also be 20 MPa to 60 MPa. By setting the press-in pressure, the adverse effects on the lenses included in the lens group 1 can be suppressed, and glass materials with different linear expansion coefficients can be used. The operating environment temperature range of the lens barrel 2 is −40° C. to +105° C. It may also be −40° C. to +125° C. This temperature range can also be applied to other members including the lens group 1.

The lens barrel 2 is made of resin in terms of easy molding by injection molding (mold-molding) or the like, lightness, and cost. As this type of resin, polycarbonate (PC) resins and polyphenylene sulfide (PPS) resins, for example, may be used. The PPS resin is suitably used because of its high rigidity and strength. In order to achieve higher strength and lower linear expansion, glass fiber, for example, may be mixed into the resin.

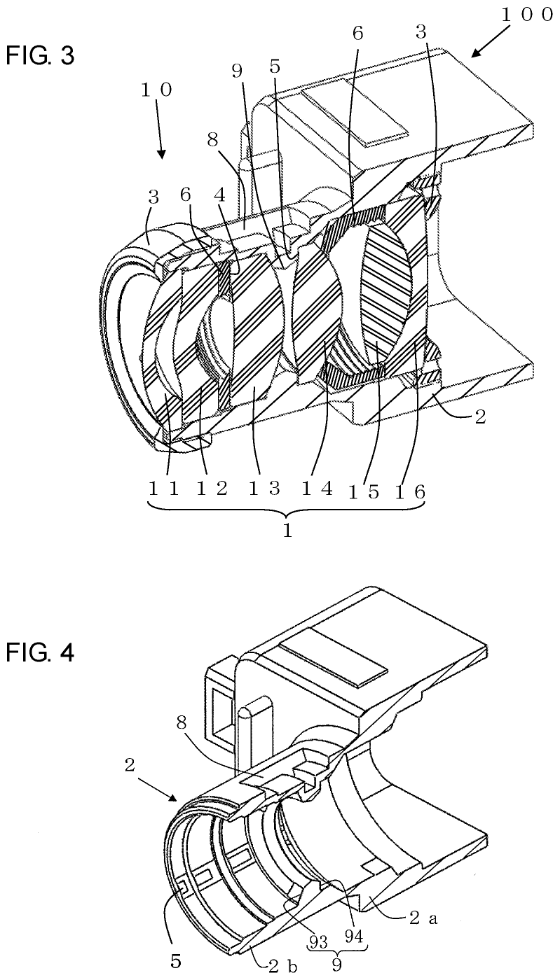

As shown in FIGS. 2 and 3, the first lens 11 and the sixth lens 16 are mounted on the end of the lens barrel 2 by the retainer 3. The retainer 3 is an annular member and is attached to the end of the object side and the image surface side of the lens barrel 2 in parallel with the optical axis direction. The retainer 3 then fastens both end lens groups 1b of the first lens 11 and the sixth lens 16 at the end of the lens barrel 2 so as to be respectively clamped in the lens barrel 2. The retainer 3 may not only hold both end lens groups 1b but may also hold the intermediate lens group 1a in the inner direction of the lens barrel 2. In other words, the second lens 12 with which the first lens 11 is abutted and the fifth lens 15 with which the sixth lens is abutted can be held in the inner direction of the lens barrel 2. The intermediate lens group 1a can hold the entire lens group 1, when adjacent lenses are abutted to an interval ring 6, as described later.

The method of fastening the retainer 3 to the lens barrel 2 is not particularly limited if there is no rattling of the lens to be fastened. For example, screw threads are cut to an inner circumferential surface of the retainer 3 and an outer circumferential surface of both ends of the lens barrel 2 respectively, and both are screwed. Alternatively, after fitting the retainer 3 to the lens barrel 2, it may be screwed from the outside with screws (not shown).

The retainer 3 may be formed of an elastic body. This is because the elastic body absorbs linear expansion of the lens unit accompanying the environmental temperature change and provides a stable pressing power in the optical axis direction. The stress due to the elastic deformation of the retainer 3 presses both end lens groups 1b into the lens barrel 2 so that it can be more securely fixed. As the elastic body, for example, metal materials such as aluminum and resin materials such as PPS may be employed. The retainer 3 may be provided with a pressing part or the like which presses the lenses contained in the both end lens groups 1b from the opening to inside respectively. The pressing part is composed, for example, of a plate spring.

As shown in FIG. 4, in the inner surface of the lens barrel 2, the inner circumferential surface where the press-fitted intermediate lens group 1a is incorporated is provided with a projection 5 to receive lenses that are press-fitted. This inner circumferential surface may be formed in a substantially circumferential surface shape (polygonal shape). The projection 5 protrudes in a chord shape (D-shape, Arc shape) into the lens barrel 2 in order to retain the outer diameter of the lens contained in the press-fitted lens group 1. The projection amount of the projection 5 may be not to block light rays narrowed down by an aperture 4. The height of protruding direction of the projection 5 may be 0.115 mm to 0.105 mm. The thickness of the projection 5 may be greater than the lens edge. The contact area between the projection 5 and the lens may be larger. The larger the contact area, the lower the stress and the more secure the lens retention. On the contrary, if the contact area is small, the stress increases and the projection 5 may be plastically deformed, resulting in lens rattling.

The projection 5 is not necessary to be provided over the entire circumference in the inner surface of the lens barrel 2. There may be at least one projection 5 to retain the outer diameter of the lens contained in the lens group 1. The projection 5 may be provided with predetermined intervals in the inner circumferential direction. For example, three or four points at predetermined intervals may be provided, so as to divide the inner circumference of the lens barrel 2 into three or four equal parts. By providing the projection 5 with predetermined intervals, even when the outer circumferential surface of the lens group 1 abuts against the projection 5, the intervals between the projections 5 create a gap to let air through between the outer circumferential surface of the lens contained in the lens group 1 and the inner circumferential surface of the lens barrel 2. As a result, the lenses contained in adjacent lens group 1 are not hermetically sealed from each other, and the pressure can be released. Therefore, the shape of the lens barrel 2 can be more restrained from being deformed.

The projection 5 may be provided for each lens of the press-fitted intermediate lens group 1a, and the shape and location may vary depending on the diameter of the lens. The projection 5 may be integrally molded with the lens barrel 2 by resin molding or the like. The projection 5 may be formed by attaching a separate member to the lens barrel 2.

As shown in FIG. 4, the lens barrel 2 has a thick wall part 2a and a thin wall part 2b. The thick wall part 2a and the thin wall part 2b have different thickness of the lens barrel 2, with the outer circumferential surface where the intermediate lens group 1a is press-fitted in response to the outer diameter of the lens. The thin wall part 2b has a concave portion 8. The concave portion 8 is formed on the outer circumferential surface of the region including the part where the projection 5 is formed on the inner circumferential surface of the lens barrel 2. The concave portion 8 can be provided by cutting, for example, the outer circumferential surface of the lens barrel 2 in the region including the part where the projection 5 is formed. This concave portion 8 may be corresponded to the location and number of positions of the projection 5 in the lens barrel 2.

Conventionally, when the intermediate lens group 1a is press-fitted into the lens barrel 2, a high stress is generated by the difference between the inner diameter of the lens barrel 2 and the outer diameter of the lens contained in the press-fitted lens group 1 due to a large rigidity of the lens barrel 2. However, the rigidity of the lens barrel 2 at a lens housing location can be relaxed to reduce the press-fit pressure of the lenses included in the lens group 1, by providing a concave portion 8. This makes it possible to press-fit lenses such as resin lenses and thin glass lenses, which have been conventionally subjected to a large load due to press-fitting, resulting in distortion and degradation of optical performance, into the lens barrel 2 as the intermediate lens group 1a.

In addition to the above, the lens barrel 2 may have a reference position 9, the interval ring 6, and the like.

The aperture 4 is provided between the second lens 12 and a third lens 13. The aperture 4 is a member that controls the quantity of light entering the lens by opening a predetermined aperture. The aperture 4 includes opening aperture and a flare aperture. The opening aperture controls the transmitted light quantity and determines the F value, which is an index of brightness. The flare aperture shields light rays that cause ghosting and aberration. In this non-limiting embodiment, the aperture 4 may be disposed between the interval ring 6, which is disposed between the second lens 12 and the third lens 13, and the object surface side of the third lens 13. This has the effect of maintaining the lens interval. As a material for the aperture 4, a metal may be used from the point such as durability. The metal includes, for example, stainless steel and aluminum, and when considering durability, stainless steel may be used.

The reference position 9 is a standard for the arrangement of the lens, when the intermediate lens group 1a is press-fitted into the lens barrel 2. The reference position 9 refers to an abutment point of a lens surface where the lens is first placed. In this non-limiting embodiment, the amount of change in the lens group 1 with the amount of change in the lens barrel 2 regarding the linear expansion of the lens barrel 2 may be reconciled. For this purpose, the reference position 9 may be provided at a substantially intermediate position in the entire lens group 1 (the position between the third lens 13 and the fourth lens 14). Providing the reference position 9 at the substantially intermediate position in the lens group 1 has the effect of making the lens unit 10 more compact than providing it at the aperture position or one side of the entire lens. The reference position 9 may be changed as needed depending on the number of lenses, their performance, and the like, and distortion is less likely to occur if the number of lenses in front and back where the reference position 9 is centered are the same.

As shown in FIG. 4, within the lens barrel 2, the third lens abutment reference surface 93 is inclined toward the image surface side. A fourth lens abutment reference surface 94 is inclined toward the object side. Since the third lens abutment reference surface 93 and the fourth lens abutment reference surface 94 are inclined respectively, the reference position 9 is formed by protruding into a roof shape. The third lens 13 is held in an appropriate position by coming in contact with the third lens abutment reference surface 93. The fourth lens 14 is held in an appropriate position by coming in contact with the fourth lens abutment reference surface 94. The reference position 9 forms at least one projection or stepped portion protruding in the circumferential direction of the lens barrel 2, and the inner circumferential surface is circular shape. The reason why the third lens abutment reference surface 93 and the fourth lens abutment reference surface 94 are each inclined is to reduce internal reflection, which affects imaging, or to make it easier to pull out a mold when it is integrally molded with the lens barrel 2.

An optical design is based on the reference position 9. The optical design can optically compensate for lens focal length variation and the expansion and contraction of the lens barrel 2, which occurs when the environmental temperature changes from the low temperature side (−40° C.) to the high temperature side (+125° C.) with respect to the reference temperature of the lens unit 10 (approximately 20° C.). At this time, the reference position 9 is disposed at the substantially intermediate position in the entire lens group 1. Therefore, it is possible to design a compensation that takes into consideration a smaller amount of change than setting a reference at the object side or the edge of the image surface side. This makes it easier to design optics and obtain more stable optical performance.

For instance, when installing the first lens 11 to the sixth lens 16 in the lens barrel 2, first, the third lens 13 from the object side of the barrel 2 and the fourth lens 14 from the image surface side are incorporated into the reference position 9. Next, the second lens 12 and the first lens 11 may be incorporated in the order of the second lens 12 and the first lens 11 from the object side of the barrel 2, and the fifth lens 15 and the sixth lens 16 may be incorporated in the order of the fifth lens 15 and the sixth lens 16 from the image surface side. At this time, the first lens group has negative refractive power, including the first lens 11 and the second lens 12. The second lens group has positive refractive power, including the third lens 13 to the sixth lens 16. The first lens group is then arranged with the second lens group via the opened aperture 4 interposed therebetween. Thus, if there is an imbalance in the length on the optical axis between the first lens group and the second lens group for the entire lens, providing the reference position 9 at the substantially intermediate position on the entire lens will optically compensate for the lens focal length variation and the expansion and contraction of the lens barrel 2, which occurs when the environmental temperature changes, resulting in stable optical performance. On the other hand, if the reference position 9 does not meet the above conditions, it may not be able to compensate optically within the temperature range used, and the optical performance may deteriorate.

The interval ring 6 is provided between the second lens 12 and the third lens 13 which are disposed at intervals, to maintain the interval between adjacent lenses. The interval ring 6 is also provided between the fourth lens 14 and the fifth lens 15 which are disposed at intervals. The interval ring 6 is a member disposed within the lens barrel 2 and may be integrally molded with the lens barrel 2, or it may be a separate member. The outer circumferential surface of this interval ring 6 abuts with the inner circumferential surface of the lens barrel 2. The interval ring 6 may be formed of metal due to its small change in temperature and high rigidity. The interval ring 6 made of metal can ensure stable optical performance in a wide temperature range. The material of the interval ring 6 includes, for example, aluminum, titanium, and stainless steel. From the viewpoint of the reduction in weight and cost, aluminum may be used as a material for the interval ring 6.

The fifth lens 15 and the sixth lens 16 are joined together to form a cemented lens. The cemented lens may be protected by disposing the fifth lens 15, which has a smaller diameter than the sixth lens 16, on the object side, so that stresses in the optical axis direction due to temperature changes do not act on the cemented surface. Laminating the fifth lens 15 and the sixth lens 16 together improves the occurrence of chromatic aberration. In addition, even when the number of lenses is increased, it can be designed to minimize the effect of misalignment that occurs during lens installation and to have lower built-in sensitivity. This cemented lens and the fourth lens 14 may be interval-specified by the interval ring 6.

### <Explanation of the Optical System>

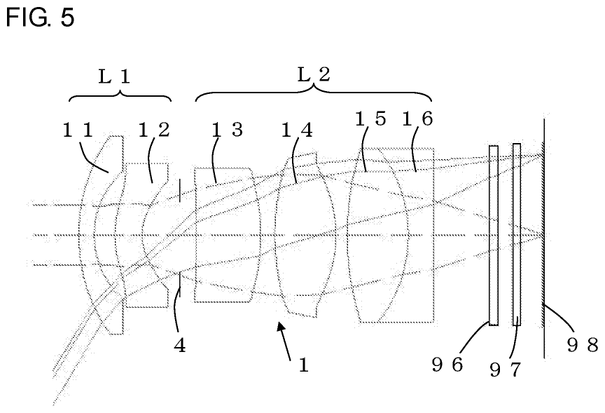

The optical system of the present disclosure will be described below in accordance with FIGS. 1 and 5. The lens unit 10 is composed of 6 elements and 5 groups. The lens unit 10 is a retrofocus type, constructed of a first lens group (L1) having a negative power (refractive power) as a whole and a second lens group (L2) having a positive power as a whole, with the aperture 4 interposed therebetween. This configuration of the lens unit 10 is designed to allow for miniaturization while ensuring sufficient back focus.

As shown in FIG. 5, the first lens group (L1) is composed of two meniscus concave lenses which are the first lens 11 and the second lens 12, in order from the object side. The second lens group (L2) is composed of convex lenses of the third lens 13, the fourth lens 14 and the fifth lens 15, and the sixth lens 16, which is a concave lens, from the object side. The fifth lens 15 and the sixth lens 16 are cemented lenses. The second lens group (L2) is composed of 4 elements and 3 groups. This cemented lens is a convex lens having positive power as a whole, composed of a pair of lenses that a convex fifth lens 15 and a concave sixth lens 16 joined together. Therefore, three group that is composed of the second lens group (L2) have a lens configuration with positive power distribution.

When using the imaging lens unit of the present disclosure as a lens unit for vehicle, it may be sufficient to ensure high imaging performance in a temperature range of −40° C. to +120° C., considering use in cold or tropical districts.

As the material of the lens barrel, a plastic, in this case PPS resin, which has excellent environmental stability may be selectively used. The optical system may be designed so that the image can be formed correctly even when the relative distance between the lens and the imaging sensor in the linear expansion of the resin lens barrel 2 changes.

One of the features of the present disclosure is the total length ratio of the first lens group to the second lens group.

When the distance from the aperture to the object side surface of the first lens group is indicated as (Df), and the distance from the aperture to the surface of the image surface side of the second lens group is indicated as (Dr),

0.346<Df/Dr<0.509 Formula (1)

may be satisfied.

If the total length ratio is below the lower limit of formula (1), the total length of the second lens group becomes too long compared to the first lens group. In this case, it may not be possible for the optical system to compensate for the linear expansion of the lens barrel 2 against temperature changes. Conversely, if it exceeds the upper limit, the lens interval in the second lens group cannot be optimized, or the interval between two lenses in the first lens group becomes large. In this case, it becomes difficult to design miniaturization.

### <First Lens Group>

When the focal length of the entire imaging optical system is indicated as “f” and the focal length of the first lens group is indicated as “f1”, as the imaging lens,

1.070<|f1/f|<1.249 Formula (2)

and

0.995<|f1/Df|<1.176 Formula (3)

may be satisfied.

In the present disclosure, the total length ratio of the first lens group is set small, as shown in formula (1) above. In order to obtain excellent imaging performance under these conditions, formulas (2) and (3) may be satisfied for the focal length of the first lens group. The parameters in formulas (2) and (3) are related to the focal length of the first lens group. By setting this range, excellent image quality can be achieved up to the periphery of the view field, as shown in the Examples below.

### <Second Lens Group>

When the focal length of the entire imaging optical system is indicated as “f” and the focal length of the second lens group is indicated as “f2”, as the imaging lens,

0.967<|f2/f|<1.108 Formula (4)

and

0.361<|f2/Dr|<0.471 Formula (5)

may be satisfied.

Similar to the first lens group described above, formulas (4) and (5) may also be satisfied for the focal length of the second lens group, in order to obtain excellent imaging performance. The parameters in formulas (4) and (5) are related to the focal length of the second lens group. By setting this range, excellent image quality can be achieved up to the periphery of the view field, as shown in the Examples below.

Each lens will be explained individually below.

### <First Lens>

The first lens 11 is the lens located on the most object side, and it captures the first incident light. Therefore, the quality of the design of this first lens 11 will affect the overall aberration correction. For a material of the first lens 11, a glass material with a small linear expansion coefficient is used, so as to facilitate the design of the operating environment temperature characteristics. The first lens 11 has a meniscus shape having a convex surface on the object side.

### <Second Lens>

The second lens 12 has a meniscus shape with a convex surface on the object side, similar to the first lens. The second lens 12 is disposed close to the first lens 11. By disposing the second lens 12 close to the first lens 11, the aperture of the first lens 11 is prevented from increasing to obtain the desired angle of incidence view.

For a glass material of the second lens 12, the selection of high-dispersion glass materials and the use of aspherical surfaces on both sides contribute to imaging performance that ensures a high MTF.

### <Third Lens>

For a material of the first third lens 13 of the second lens group (L2), which is first disposed from the aperture 4, it may be possible to use a glass material with high refractive index and high dispersion like the second lens. A higher MTF can be ensured by approximating the dispersion characteristics of the adjacent lenses of the first lens group (L1) and the second lens group (L2) with the aperture 4 interposed therebetween.

For example, in each Example described below, it is selected for the glass material that a value (υd) indicating the dispersion characteristics of the second lens 12 at the d-line (wavelength 589.29 nm) is 31.1, and a value indicating the dispersion characteristics of the third lens 13 is 37.4. An appropriate optical system can be achieved by selecting the glass material whose value for the dispersion characteristics of both lenses is less than 40.

### <Fourth Lens>

The fourth lens 14 is the most powerful biconvex lens, and a glass material with a negative refractive index temperature coefficient (dn/dt) and a large linear expansion coefficient may be selectively used. This allows the optical characteristics of the lens itself to change in response to the temperature change of the lens barrel 2. Then, the entire optical system can be designed to image correctly on the surface of the imaging sensor.

A low-dispersion glass material may be used for the fourth lens 14 so as not to adversely affect chromatic aberration even when the optical characteristics change in response to the temperature change. In the Examples described below, the glass material that the refractive index temperature coefficient (D-line) at 20° C. to 40° C. is −6.6×10⁻⁶° C. (dn/dt) is used for the fourth lens 14. The linear expansion coefficient α (20/120 degrees (10⁻⁷/° C.)) of the glass material is 141. By choosing this type of glass material for the fourth lens 14, it is possible to achieve an optical design that allows for temperature compensation and maintain high imaging performance over a wide environmental temperature range of −40° C. to 120° C. The fourth lens 14 is the biconvex lens that obtains the greatest amount of power for this optical system, and the imaging performance of the optical system itself can be improved by making the object side and the image surface side aspherical.

### <Fifth Lens and Sixth Lens>

The fifth lens 15 and the sixth lens 16 are laminated (joined) together. This allows the fifth lens 15 and the sixth 16 to be designed to improve the occurrence of chromatic aberration, minimize the effect of misalignment that occurs during lens installation, and have lower built-in sensitivity, even when the number of lenses is increased.

The aspherical surfaces employed in the wide-angle lenses (the first lens 11 to the sixth lens 16) of the present non-limiting embodiment are all represented by the following aspherical formula. In the formula, “h” stands for the height in the direction perpendicular to the optical axis, “Z” stands for the amount of displacement in the optical axis direction at height “h” (sag amount), “r” stands for the curvature radius of the reference spherical surface (paraxial curvature radius), and “k” stands for the conical coefficient. “A”, “B”, “C”, and “D” respectively represent the 4th, 6th, 8th, and 10th order aspherical surface coefficients. These values are shown in Tables for each numerical example. In a table showing the aspherical surface coefficient, “E-04” means “×10⁻⁴”.

$$z = \frac{\frac{{h}^{2}}{r}}{1 + \sqrt{1 - \frac{( 1 + k ) {h}^{2}}{{r}^{2}}}} + {Ah}^{4} + {Bh}^{6} + {Ch}^{8} + ⋯ \qquad [ Mathematical Expression 1 ]$$

### NUMERICAL EXAMPLE

As numerical examples, five Examples are prepared and evaluated with the following optical system quantities, with a built-in reference position disposed between the third lens and the fourth lens of the second lens group L2, and with the first lens and the sixth lens held down from the object side and the image surface side. The lens configuration is schematically shown in FIG. 5. The same reference numerals are placed on the same parts as the above described parts, and the explanation is omitted.

At this time, a cover glass (CG) 97 and an IR (infrared) cut filter (IRCF) 96 are installed in front of the image surface (imaging sensor surface) 98. The solid line through each lens shows the peripheral luminous flux and the dashed line shows the central luminous flux. Each value for the lens group 1 is shown below.
Focal length f=5.325 mm
FNo.=1.6
Horizontal angle of view=112 degrees

As a numerical example 1, an optical system of 6 elements and 5 groups with the following lens data is designed. The surface numbers in Table 1 are the numbers of each lens surface that constitute the optical system and are sequential numbers from the object side. The curvature “R” indicates the curvature radius of each lens surface. The interval is the distance between the surfaces on the optical axis. The term “aspherical surface” in the table refers to aspherical surface lenses, while the others are spherical surface lenses.

The “nd” in the table is the refractive index at the d-line (wavelength 589.29 nm). The “vd” is also a value for the dispersion characteristics at the d-line (wavelength 589.29 nm).

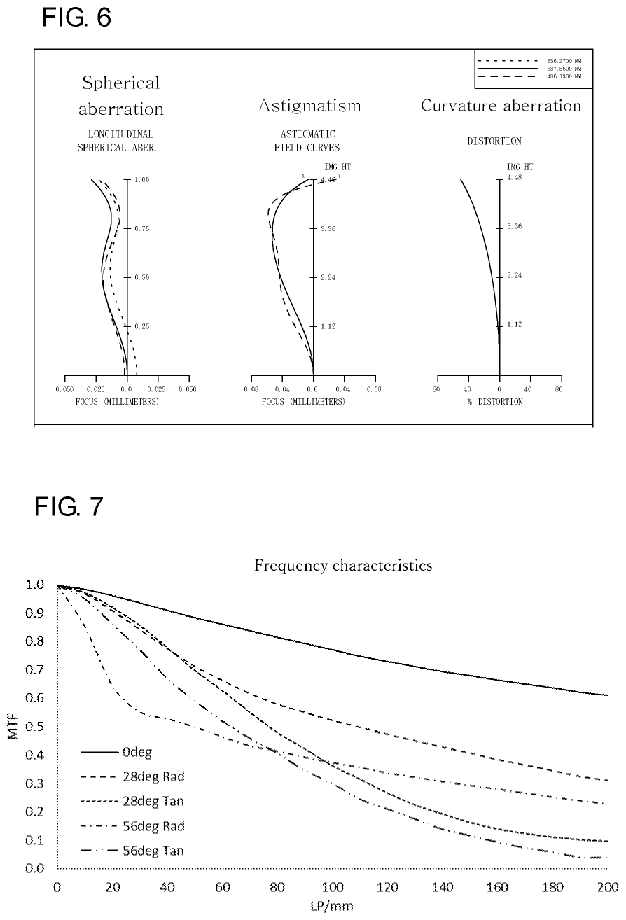

Table 2 shows the numerical examples 1 of the aspherical surface numbers 5, 6, 10, and 11. The aberration characteristic diagram of this Example 1 is shown in FIG. 6, and the MTF characteristic diagram is shown in FIG. 7.

TABLE 1

| | | | | Refractive | |
|---|---|---|---|---|---|
| Surface | | | | Index | Dispersion |
| Number | | Curvature R | Interval | (nd) | (vd) |
| 3 | | 9.2674 | 0.9000 | 1.54678 | 62.7 |
| 4 | | 4.2289 | 1.2329 | | |
| 5 | Aspherical | 4.7046 | 1.5863 | 1.68894 | 31.1 |
| | Surface | | | | |
| 6 | Aspherical | 2.6878 | 1.9942 | | |
| | Surface | | | | |
| 7 | Aperture | ∞ | 0.2279 | | |
| 8 | | −21.6901 | 3.1000 | 1.90043 | 37.4 |
| 9 | | −9.0817 | 0.9000 | | |
| 10 | Aspherical | 17.9596 | 3.6000 | 1.49700 | 81.6 |
| | Surface | | | | |
| 11 | Aspherical | −6.2480 | 0.5568 | | |
| | Surface | | | | |
| 12 | | 19.3175 | 3.6000 | 1.72916 | 54.7 |
| 13 | | −7.0500 | 1.0500 | 1.92286 | 20.9 |
| 14 | | −43.2278 | 2.3518 | | |
| 15 | | ∞ | 0.5000 | | |
| 16 | | ∞ | 0.1000 | | |
| 17 | | ∞ | 1.5000 | | |
| 18 | IRCF | ∞ | 0.5000 | 1.51633 | 64.1 |
| 19 | | ∞ | 1.1900 | | |
| 20 | CG | ∞ | 0.0100 | 1.51633 | 64.1 |
| 21 | | ∞ | 0.1131 | | |

TABLE 2

| | S5 | S6 | S10 | S11 |
|---|---|---|---|---|
| r | 4.70461E+00 | 2.68777E+00 | 1.79596E+01 | −6.24798E+00 |
| k | −3.39363E+00 | −1.89796E+00 | 8.78846E+00 | −4.40345E−01 |
| A | 1.60298E−04 | 3.97211E−03 | −5.51050E−05 | 1.62900E−05 |
| B | −3.94858E−04 | −9.62228E−04 | −8.28628E−06 | 3.15471E−05 |
| C | 1.14764E−05 | 7.02225E−05 | 1.01066E−06 | −2.11760E−06 |
| D | 1.56900E−07 | 0.00000E+00 | 3.96148E−09 | 1.00786E−07 |

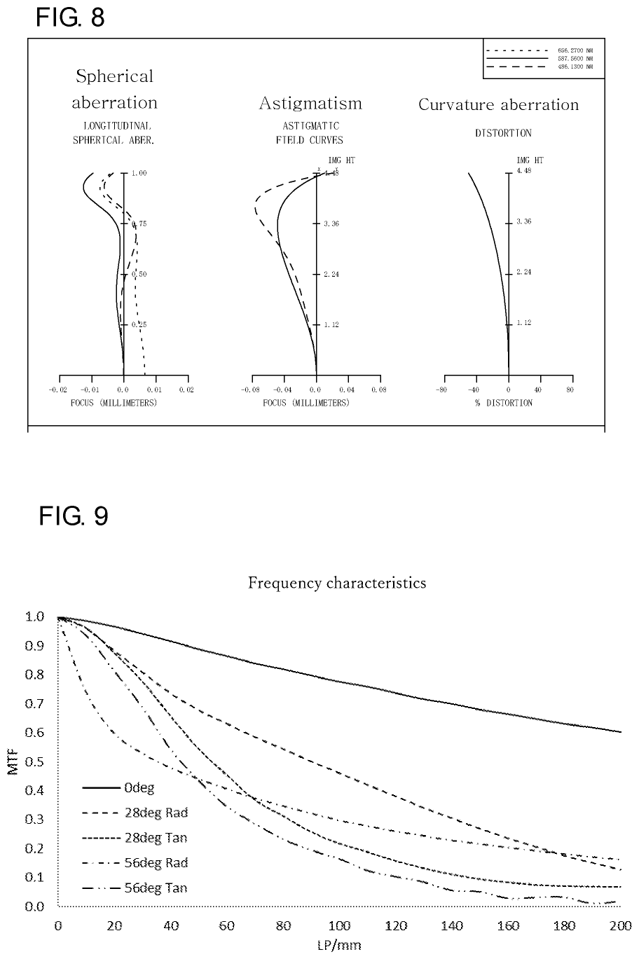

As a numerical example 2, an optical system of 6 elements and 5 groups with the following lens data is designed. The aberration characteristic diagram of this Example 2 is shown in FIG. 8, and the MTF characteristic diagram is shown in FIG. 9.

TABLE 3

| | | | | Refractive | |
|---|---|---|---|---|---|
| Surface | | | | Index | Dispersion |
| Number | | Curvature R | Interval | (nd) | (vd) |
| 3 | | 9.2852 | 0.900 | 1.54678 | 62.7 |
| 4 | | 4.1748 | 1.330 | | |
| 5 | Aspherical | 5.5060 | 2.061 | 1.68894 | 31.1 |
| | Surface | | | | |
| 6 | Aspherical | 2.8223 | 1.437 | | |
| | Surface | | | | |
| 7 | Aperture | ∞ | 0.173 | | |
| 8 | | −37.0000 | 3.271 | 1.90043 | 37.4 |
| 9 | | −8.9405 | 0.585 | | |
| 10 | Aspherical | 31.6981 | 3.399 | 1.49700 | 81.6 |
| | Surface | | | | |
| 11 | Aspherical | −5.7759 | 0.933 | | |
| | Surface | | | | |
| 12 | | 14.9822 | 3.600 | 1.72916 | 54.7 |
| 13 | | −7.0500 | 2.113 | 1.92286 | 20.9 |
| 14 | | −54.2127 | 1.298 | | |
| 15 | | ∞ | 0.500 | | |
| 16 | | ∞ | 0.100 | | |
| 17 | | ∞ | 1.500 | | |
| 18 | IRCF | ∞ | 0.500 | 1.51633 | 64.1 |
| 19 | | ∞ | 1.190 | | |
| 20 | CG | ∞ | 0.010 | 1.51633 | 64.1 |
| 21 | | ∞ | 0.102 | | |

TABLE 4

| | S5 | S6 | S10 | S11 |
|---|---|---|---|---|
| r | 5.50599E+00 | 2.82234E+00 | 3.16981E+01 | −5.77589E+00 |
| k | −5.06178E+00 | −1.98982E+00 | 9.99738E+00 | −2.15200E−01 |
| A | 7.63393E−04 | 4.79352E−03 | 1.75120E−04 | 3.42151E−05 |
| B | −3.07064E−04 | −8.57566E−04 | 8.91516E−07 | 3.03516E−05 |
| C | 2.71502E−06 | 6.51043E−05 | 6.61691E−07 | −2.33880E−06 |
| D | 3.66660E−07 | 0.00000E+00 | 5.77303E−08 | 1.52067E−07 |

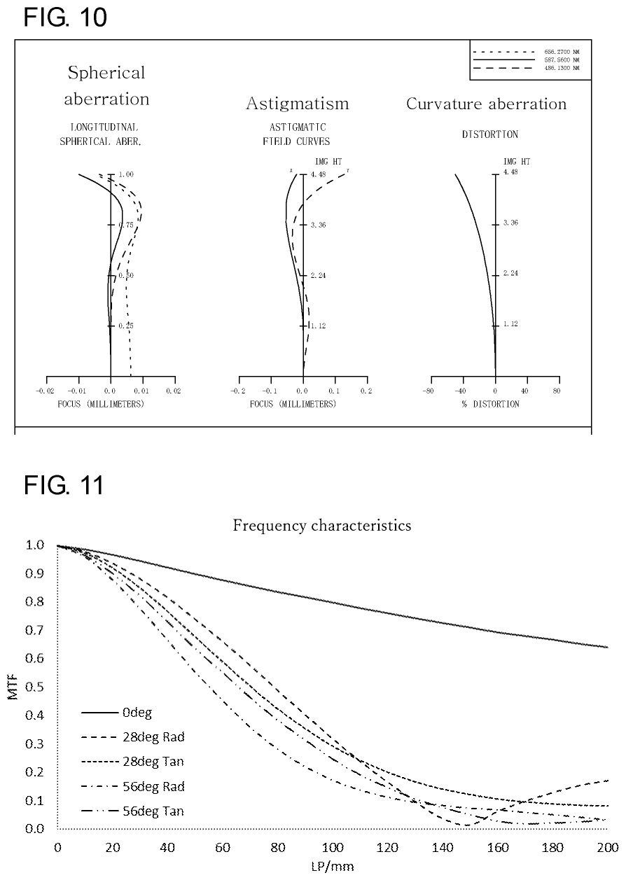

As a numerical example 3, an optical system of 6 elements and 5 groups with the following lens data is designed. The aberration characteristic diagram of this Example 3 is shown in FIG. 10, and the MTF characteristic diagram is shown in FIG. 11.

TABLE 5

| | | | | Refractive | |
|---|---|---|---|---|---|
| Surface | | | | Index | Dispersion |
| Number | | Curvature R | Interval | (nd) | (vd) |
| 3 | | 8.8587 | 0.900 | 1.54678 | 62.7 |
| 4 | | 4.2369 | 1.181 | | |
| 5 | Aspherical | 4.5565 | 1.500 | 1.68894 | 31.1 |
| | Surface | | | | |
| 6 | Aspherical | 2.7562 | 2.074 | | |
| | Surface | | | | |
| 7 | Aperture | ∞ | 0.188 | | |
| 8 | | −31.1425 | 3.400 | 1.90043 | 37.4 |
| 9 | | −9.1412 | 1.256 | | |
| 10 | Aspherical | 21.2514 | 3.398 | 1.49700 | 81.6 |
| | Surface | | | | |
| 11 | Aspherical | −6.3271 | 0.225 | | |
| | Surface | | | | |
| 12 | | 15.1869 | 3.600 | 1.72916 | 54.7 |
| 13 | | −7.6826 | 2.377 | 1.92286 | 20.9 |
| 14 | | 3711.6311 | 1.001 | | |
| 15 | | ∞ | 0.500 | | |
| 16 | | ∞ | 0.100 | | |
| 17 | | ∞ | 1.500 | | |
| 18 | IRCF | ∞ | 0.500 | 1.51633 | 64.1 |
| 19 | | ∞ | 1.190 | | |
| 20 | CG | ∞ | 0.010 | 1.51633 | 64.1 |
| 21 | | ∞ | 0.097 | | |

TABLE 6

| | S5 | S6 | S10 | S11 |
|---|---|---|---|---|
| r | 4.55648E+00 | 2.75623E+00 | 2.12514E+01 | −6.32714E+00 |
| k | −6.23762E+00 | −2.28151E+00 | −8.25840E+00 | −3.06605E−01 |
| A | 4.03402E−03 | 5.79515E−03 | 3.17955E−04 | 2.33950E−04 |
| B | −8.34362E−04 | −1.12841E−03 | −3.10475E−05 | −3.68990E−07 |
| C | 4.17033E−05 | 7.14962E−05 | 2.44854E−06 | 1.39190E−07 |
| D | −7.54686E−07 | 0.00000E+00 | −5.53093E−08 | 1.45850E−08 |

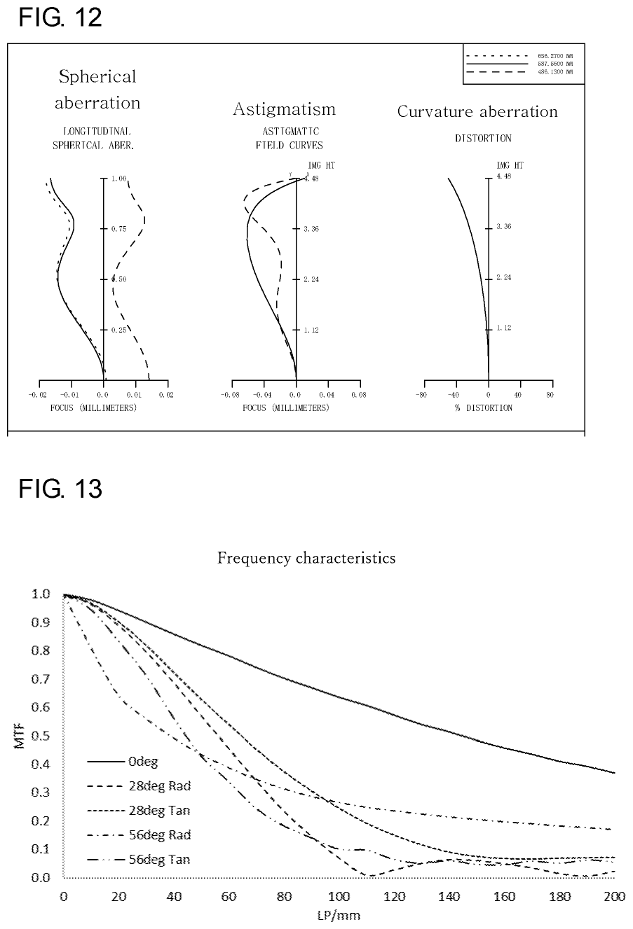

As a numerical example 4, an optical system of 6 elements and 5 groups with the following lens data is designed. The aberration characteristic diagram of this Example 4 is shown in FIG. 12, and the MTF characteristic diagram is shown in FIG. 13.

TABLE 7

| | | | | Refractive | |
|---|---|---|---|---|---|
| Surface | | | | Index | Dispersion |
| Number | | Curvature R | Interval | (nd) | (vd) |
| 3 | | 8.9986 | 0.900 | 1.54678 | 62.7 |
| 4 | | 4.1287 | 1.412 | | |
| 5 | Aspherical | 6.6879 | 2.375 | 1.68894 | 31.1 |
| | Surface | | | | |
| 6 | Aspherical | 3.2746 | 1.127 | | |
| | Surface | | | | |
| 7 | Aperture | ∞ | 0.175 | | |
| 8 | | −32.7349 | 3.400 | 1.90043 | 37.4 |
| 9 | | −8.8651 | 0.535 | | |
| 10 | Aspherical | 28.1533 | 3.400 | 1.49700 | 81.6 |
| | Surface | | | | |
| 11 | Aspherical | −5.7268 | 0.537 | | |
| | Surface | | | | |
| 12 | | 14.2208 | 3.400 | 1.72916 | 54.7 |
| 13 | | −7.5952 | 2.839 | 1.92286 | 20.9 |
| 14 | | −98.7008 | 1.000 | | |
| 15 | | ∞ | 0.500 | | |
| 16 | | ∞ | 0.100 | | |
| 17 | | ∞ | 1.500 | | |
| 18 | IRCF | ∞ | 0.500 | 1.51633 | 64.1 |
| 19 | | ∞ | 1.190 | | |
| 20 | CG | ∞ | 0.010 | 1.51633 | 64.1 |
| 21 | | ∞ | 0.109 | | |

TABLE 8

| | S5 | S6 | S10 | S11 |
|---|---|---|---|---|
| r | 6.68786E+00 | 3.27457E+00 | 2.81533E+01 | −5.72683E+00 |
| k | −5.62154E+00 | −2.20469E+00 | 5.63421E+00 | −3.69654E−01 |
| A | 8.17277E−05 | 4.26833E−03 | 2.22300E−04 | −1.40021E−04 |
| 8 | −1.60002E−04 | −5.51000E−04 | −1.54123E−06 | 4.51015E−05 |
| C | −3.67865E−06 | 4.04290E−05 | 8.62888E−07 | −4.13719E−06 |
| D | 3.82121E−07 | 0.00000E+00 | 6.09935E−08 | 2.17521E−07 |

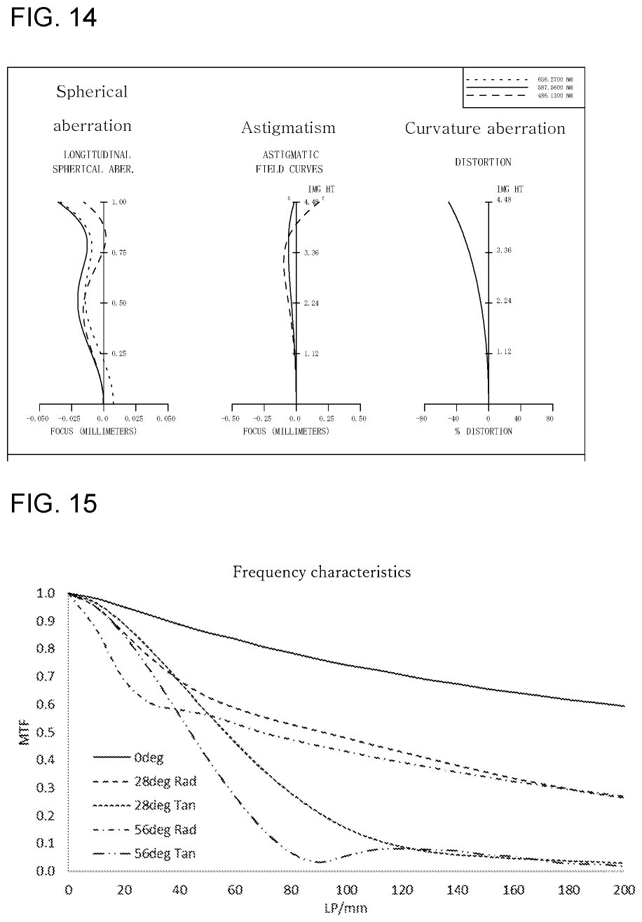

As a numerical example 5, an optical system of 6 elements and 5 groups with the following lens data is designed. The aberration characteristic diagram of this Example 5 is shown in FIG. 14, and the MTF characteristic diagram is shown in FIG. 15.

TABLE 9

| | | | | Refractive | |
|---|---|---|---|---|---|
| Surface | | | | Index | Dispersion |
| Number | | Curvature R | Interval | (nd) | (vd) |
| 3 | | 9.7902 | 0.900 | 1.54678 | 62.7 |
| 4 | | 4.4792 | 1.112 | | |
| 5 | Aspherical | 4.4000 | 1.500 | 1.68894 | 31.1 |
| | Surface | | | | |
| 6 | Aspherical | 2.5012 | 2.180 | | |
| | Surface | | | | |
| 7 | Aperture | ∞ | 0.118 | | |
| 8 | | −28.3868 | 3.330 | 1.90043 | 37.4 |
| 9 | | −9.2402 | 1.637 | | |
| 10 | Aspherical | 20.2083 | 3.223 | 1.49700 | 81.6 |
| | Surface | | | | |
| 11 | Aspherical | −6.3959 | 0.626 | | |
| | Surface | | | | |
| 12 | | 25.4909 | 2.730 | 1.72916 | 54.7 |
| 13 | | −7.0501 | 0.850 | 1.92286 | 20.9 |
| 14 | | −29.6186 | 3.130 | | |
| 15 | | ∞ | 0.500 | | |
| 16 | | ∞ | 0.100 | | |
| 17 | | ∞ | 1.500 | | |
| 18 | IRCF | ∞ | 0.500 | 1.51633 | 64.1 |
| 19 | | ∞ | 1.190 | | |
| 20 | CG | ∞ | 0.010 | 1.51633 | 64.1 |
| 21 | | ∞ | 0.111 | | |

TABLE 10

| | S5 | S6 | S10 | S11 |
|---|---|---|---|---|
| r | 4.40000E+00 | 2.50119E+00 | 2.02083E+01 | −6.39593E+00 |
| k | −3.41829E+00 | −1.95618E+00 | 5.75783E+00 | −1.76064E+00 |
| A | 4.72571E−04 | 4.49870E−03 | 9.25806E−05 | −4.14948E−04 |
| B | −5.68789E−04 | −1.17828E−03 | −3.96388E−05 | −1.05893E−05 |
| C | 3.00860E−05 | 8.47860E−05 | 3.29092E−06 | 9.19851E−07 |
| D | −4.33855E−07 | 0.00000E+00 | −6.84223E−08 | −6.29351E−11 |

Table 11 below summarizes the parameter conditional formulas (1) to (6) shown in the text for the numerical examples 1 to 5 described above.

TABLE 11

| | | | | | | Condi- | Condi- | Condi- | Condi- | Condi- | | | Condi- |
|---|---|---|---|---|---|---|---|---|---|---|---|---|---|
| | | | | | | tional | tional | tional | tional | tional | | | tional |
| | | | | | | Formu- | Formu- | Formu- | Formu- | Formu- | | | Formu- |
| | | | | | | la 1 | la 2 | la 3 | la 4 | la 5 | | | la 6 |
| | f | f1 | f2 | Df | Dr | Df/Dr | \|f1/f\| | \|f1/Df\| | \|f2/f\| | \|f2/Dr\| | f4 | D4r | f4/D4r |
| Example 1 | 5.325 | −6.206 | 5.615 | 5.713 | 13.035 | 0.438 | 1.165 | 1.086 | 1.054 | 0.431 | 9.767 | 11.472 | 0.851 |
| Example 2 | 5.325 | −5.700 | 5.309 | 5.783 | 14.074 | 0.411 | 1.070 | 0.986 | 0.997 | 0.377 | 10.089 | 11.847 | 0.852 |
| Example 3 | 5.325 | −6.876 | 5.504 | 5.656 | 14.444 | 0.392 | 1.291 | 1.216 | 1.034 | 0.381 | 10.182 | 11.099 | 0.917 |
| Example 4 | 5.325 | −5.892 | 5.150 | 5.815 | 14.286 | 0.407 | 1.106 | 1.013 | 0.967 | 0.361 | 9.860 | 11.684 | 0.844 |
| Example 5 | 5.325 | −6.161 | 5.700 | 5.692 | 12.514 | 0.455 | 1.157 | 1.082 | 1.070 | 0.455 | 10.139 | 11.247 | 0.901 |

As shown in Table 11, it can be seen from the aberration and MTF characteristic diagrams shown in FIGS. 6 through 15 that the imaging lenses of the present disclosure have excellent optical performance in wide-angle lenses with an angle of view exceeding 100 degrees.

In the above explanation of the present disclosure, the optical system composed of 6 elements and 5 groups has been described as an example, but the number of lenses and the composition are not limited and can be changed as necessary depending on the application.

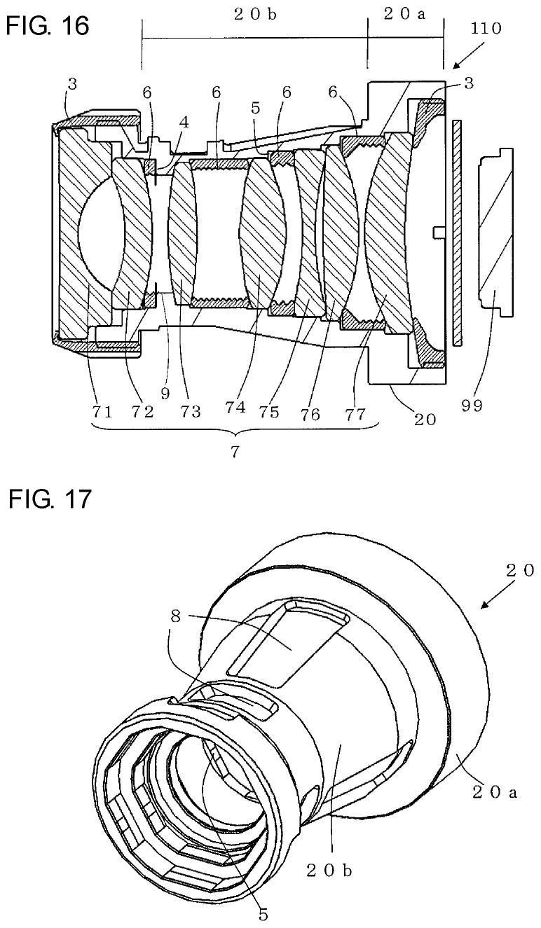

While the above explanation is based on the optical system of 6 elements and 5 groups, in Example 6, a simulation of the stress load on the lens and the lens barrel is conducted using a lens unit 110 with a lens group 7 of 7 elements and 7 groups and a lens barrel 20, as shown in FIGS. 16 and 17. The lens group 7 includes a first lens 71 to a seventh lens 77. The reference position 9 in Example 6 is set between a second lens 72 and a third lens 73.

As Example 6, the lens unit 110 shown in FIGS. 16 and 17 is prepared. The seven lenses of the first lens 71 to the seventh lens 77 in the lens unit 110 include the second lens 72 to a six lens 76 (hereinafter “the intermediate lens group 7a”) which are press-fitted into the lens barrel 20, and the first lens 71 on the most object side that is fastened to both ends of the barrel 20 and the seventh lens 77 (hereinafter “both end lens group 7b”) on the most side of image sensor 99 (image surface side). The intermediate lens group 7a is respectively press-fitted and incorporated into the lens barrel 20 and held on the outer diameter by the chord-shaped projection 5 in the lens barrel 20. The interval ring 6 is installed between each lens of the intermediate lens group 7a to maintain intervals between the lenses. The aperture 4 is installed at the rear end of the interval ring 6 at the rear end of the second lens 72. When the lens group 7 is incorporated from both ends of the lens barrel 20, a protruding portion is formed on the inner circumferential surface of the lens barrel 20 as the reference position where the periphery of one surface of the incorporated lens group 7 comes into contact at the substantially intermediate position of the entire lens group 7.

In Example 6, the protruding portion formed between the second lens 72 and the third lens 73 is the reference position 9. Regarding the reference position 9, the periphery of the image surface side of the second lens 72 is pressed and positioned via the interval ring 6 and the aperture 4. The periphery of the object side of the third lens 73 is positioned in direct contact with the reference position 9. On the other hand, both end lens groups 7b are fastened to both ends of the lens barrel 20 by sandwiching them with the retainer 3 respectively. The thickness of the lens barrel 20 becomes thicker from the object side to the image surface side, and it has a thick wall part 20a and a thin wall part 20b.

When the lens group 7 is mounted on the lens barrel 20, stress is loaded so as the amount of deformation (press-fitting amount) to be 0.015 mm each. In Example 6, an optical glass lens is used as the lens group 7, the lens barrel 20 is made of PPS resin, and the projection 5 is integrally molded on the inner surface. The retainer 3 is made of PPS resin, and the interval ring 6 is made of aluminum alloy. Each diameter of the lens group 7 and each contact area of the lens group 7 with the inner circumferential surface of the lens barrel 2 and the projection 5 are shown in Table 12. The contact area refers to the area where the outer circumferential surface (edge) of the lens group 7 is press-fitted into the projection 5. The contact area depends on the outer diameter of the lens group 7 and the wall thickness of the lens edge.

As shown in FIG. 17, a region including the thin wall part 20b with the projection 5 formed on the inner circumference surface is formed on the outer circumferential surface of the lens barrel 20. A concave portion 8 formed in this region is intended to control the press-fitting amount due to differences in the outer diameter of the lens group 7 which is press-fitted into the inside of the lens barrel 20. The concave portion 8 is formed on the outer circumferential surface of the region including the area where the projection 5 is formed on the inner circumferential surface, with three thinner portions in the thin wall part 20b in front and back, each in the circumferential direction of the lens barrel 20, so as to make the thickness 0.75 to 0.85 mm thinner than the outer circumferential surface of the other lens barrel 2 (the thick wall part 20a), in accordance with the outer diameter of the lens group 7. The results are shown in Table 12.

TABLE 12

| | | | | Without Concave Portion | | | With Concave Portion | | |
|---|---|---|---|---|---|---|---|---|---|
| | | | | | Stress | Force | | Stress | Force |
| | | Press- | | Thickness | Required | per | Thickness | Required | per |
| | | fitting | Contact | of Lens | for Press- | Contact | of Lens | for Press- | Contact |
| | Diameter | Amount | Area | Barrel | fitting | Area | Barrel | fitting | Area |
| | (mm) | (mm) | (mm²) | (mm) | (Mpa) | (N) | (mm) | (Mpa) | (N) |
| Lens 71 | 10.5 | 0.015 | 0.59 | 1.25 | 34.9 | 20.5 | 1.25 | 26.1 | 15.3 |
| Lens 72 | 9 | 0.015 | 0.62 | 1.25 | 117.3 | 72.3 | 0.40 | 63.0 | 38.9 |
| Lens 73 | 8.5 | 0.015 | 0.44 | 1.25 | 244.9 | 106.6 | 0.50 | 67.9 | 29.6 |
| Lens 74 | 9 | 0.015 | 0.56 | 1.50 | 142.2 | 79.4 | 0.75 | 46.6 | 26.0 |
| Lens 75 | 10 | 0.015 | 0.62 | 1.50 | 116.9 | 72.4 | 0.75 | 39.0 | 24.1 |
| Lens 76 | 10.5 | 0.015 | 0.38 | 1.50 | 150.8 | 57.4 | 0.75 | 55.9 | 21.3 |
| Lens 77 | 12 | 0.015 | 0.63 | 1.60 | 61.3 | 38.5 | 1.60 | 59.9 | 37.6 |

The lens unit of Example 6 neither breaks or damages the lens or the lens barrel, because the stresses applied to the lens and the lens barrel are both reduced when the lens is press-fitted.

Furthermore, as shown in Table 1, the thin wall part 20b becomes a thinner structure and the rigidity of the lens barrel 20 in the lens accommodation is reduced, by providing a concave portion 8 in the thin wall part 20b of the outer circumferential surface of the projection 5. Therefore, the force per ground contact area of the intermediate lens group 7a press-fitted into the lens barrel 20 is suppressed, and the variation in the force applied to the lens group 7 can be further controlled.

In the imaging lens unit of the present disclosure, the intermediate lens group is incorporated in the lens barrel with a minimum press-in pressure, and the both end lenses are disposed on both sides of the intermediate lens group in the optical axis direction, and are fastened in the lens barrel by retainers. Therefore, the pressure created in the lens barrel and lens can be reduced.

In the imaging lens unit of the present disclosure, the first to sixth lenses including two lenses of the first lens group and four lenses of the second lens group are disposed in the lens barrel made of resin as a reference position between the third lens and the fourth lens. As a result, focal length variations of the lens and expansion and contraction of the lens barrel due to temperature changes from low to high temperatures can be mitigated and stable optical performance can be obtained.

Although the imaging lens unit of the non-limiting embodiments of the present disclosure has been described above, the present disclosure is not limited to the above non-limiting embodiments, and various improvements and modifications can be made within the scope of the claims. For example, the imaging lens unit of the present disclosure does not cause rattling between the lens barrel and the lens after press-fitting, not only in terms of vibration resistance but also in terms of temperature changes, since the lens barrel made of resin is capable of absorbing linear expansion caused by changes in environmental temperature. Therefore, the imaging lens unit can be used not only for camera devices such as vehicle cameras, but also for equipment such as scanners and projectors, for example, in which heat from a light source causes a large temperature change in the lens or the lens barrel.

### DESCRIPTION OF THE REFERENCE NUMERALS

1: Lens Group

1a: Intermediate Lens Group

1b: Both End Lens Groups

2: Lens Barrel

2a: Thick Wall Part

2b: Thin Wall Part

3: Retainer

4: Aperture

5: Projection

6: Interval Ring

8: Concave Portion

9: Reference Position

10: Lens Unit

7: Lens Group

7a: Intermediate Lens Group

7b: Both End Lens Groups

20: Lens Barrel

100: Camera

110: Lens Unit

L1: First Lens Group

L2: Second Lens Group

1. An imaging lens unit comprising:
a plurality of lenses, and
a lens barrel made of resin in which the plurality of lenses are incorporated therein, wherein
the plurality of lenses comprises, in order from an object side, a first lens group having a negative refractive power and a second lens group having a positive refractive power, with an aperture interposed therebetween,
the first lens group comprises, from the object side, a meniscus lens as a first lens having a negative refractive power in which a convex surface is formed on the object side, and a meniscus lens as a second lens having a negative refractive power in which a convex surface on the object side is formed,
the second lens group comprises, from the object side, a convex lens as a third lens having a positive refractive power, a biconvex lens as a fourth lens having a positive refractive power, a biconvex lens as a fifth lens having a positive refractive power, and a concave lens as a sixth lens having a negative refractive power, and
the first lens to the sixth lens are incorporated in the lens barrel with a reference position between the third lens and the fourth lens of the second lens group, wherein the first lens to the third lens are incorporated from the object side of the lens barrel, and the fourth lens to the sixth lens are incorporated from the image surface side.

2. An imaging lens unit comprising:
a plurality of lenses comprising:
a first lens group,
an intermediate lens group, and
a second lens group; and
a lens barrel made of resin in which the plurality of lenses are incorporated therein, wherein
the plurality of lenses comprises the intermediate lens group press-fitted into the lens barrel and the first lens group and the second lens group disposed on either side of the intermediate lens group in the optical axis direction and fastened in the lens barrel by retainers.

3. The imaging lens unit according to claim 1, wherein
both end lenses comprising the first lens and the sixth lens are fastened to the lens barrel by retainers.

4. The imaging lens unit according to claim 2, wherein the retainer comprises an elastic body.

5. The imaging lens unit according to claim 1, wherein the fifth lens and the sixth lens of the second lens group are joined together, the sixth lens is larger in diameter than the fifth lens, and
an interval between the sixth lens and the fourth lens is specified by an interval ring made of metal.

6. The imaging lens unit according to claim 1, wherein
at least one projection protruded in a chord shape into the lens barrel, in which the intermediate lens group is incorporated by press-fit, is formed on an inner circumferential surface of the lens barrel.

6. The imaging lens unit according to claim 6, wherein
the lens barrel comprises a thick wall part and a thin wall part; and
the thin wall part comprises a concave portion formed on an outer circumferential surface of a region comprising the part where the at least one projection is formed on the inner circumferential surface.

8. The imaging lens unit according to claim 26, wherein
a plurality of projections each protrude in a chord shape into the lens barrel, in which the incorporated intermediate lens group is press-fitted, are formed at predetermined intervals on an inner circumferential surface of the lens barrel.

9. The imaging lens unit according to claim 6, wherein
the at least one projection is configured as the reference position where athe periphery of one surface of a lens of the plurality of lens and a periphery of one surface of another lens of the plurality of lens is abutted, when the plurality of lenses are incorporated from both ends of the lens barrel.

10. An electronic device, comprising:
the imaging lens unit of claim 1.

11. The imaging lens unit according to claim 3, wherein
the retainer comprises an elastic body.

12. The imaging lens unit according to claim 1 wherein
at least one projection protruded in a chord shape into the lens barrel is formed on an inner circumferential surface of the lens barrel.

13. The imaging lens unit according to claim 12, wherein
the at least one projection is configured as the reference position where a periphery of one surface of the third lens and a periphery of one surface of the fourth lens, is abutted, when the plurality of lenses are incorporated from both ends of the lens barrel.

14. The imaging lens unit according to claim 1, wherein
a plurality of projections each protrude in a chord shape into the lens barrel and are formed at predetermined intervals on an inner circumferential surface of the lens barrel.

15. The imaging lens unit according to claim 12, wherein
the lens barrel comprises a thick wall part and a thin wall part; and
the thin wall part comprises a concave portion formed on an outer circumferential surface of a region comprising the part where the at least one projection is formed on the inner circumferential surface.

16. An electronic device, comprising:
the imaging lens unit of claim 2.
